(19) United States
(12) Patent Application Publication
(10) Pub. No.: US 2026/0086904 A1
(43) Pub. Date: Mar. 26, 2026

(54) PROGRAM EXECUTION METHOD, DEVICE, APPARATUS, AND STORAGE MEDIUM

(71) Applicant: Lenovo (Beijing) Limited, Beijing (CN)

(72) Inventors: Tianhao SAI, Beijing (CN); Kang ZHU, Beijing (CN); Bingxun SHI, Beijing (CN)

(21) Appl. No.: 19/328,962

(22) Filed: Sep. 15, 2025

(30) Foreign Application Priority Data
Sep. 24, 2024 (CN) 202411336677.2

(51) Int. Cl. G06F 11/20; G06F 9/4401; G06F 9/54; G06F 11/07

(52) U.S. Cl. CPC G06F 11/2038; G06F 9/4405; G06F 9/544; G06F 11/0793; G06F 11/2028

(57) ABSTRACT

A program execution method includes: during a Unified Extensible Firmware Interface (UEFI) boot process, determining a core in a processor that executes a UEFI application as a first core; using the first core to allocate a first function code in the UEFI application to a second core in the processor for execution, the first core being different from the second core, the first function code being code for executing a UEFI boot task; and in response to an abnormality in the second core, using the first core to allocate the first function code to a third core in the processor for execution, the third core being different from the first and second cores.

### CROSS-REFERENCE TO RELATED APPLICATION(S)

This application claims priority to Chinese Patent Application No. 202411336677.2 filed on Sep. 24, 2024, which is incorporated herein by reference in its entirety.

### FIELD OF THE TECHNOLOGY

The present disclosure relates to a field of computer technology, and in particular to a program execution method, device, apparatus, and storage medium.

### BACKGROUND

Certain existing Unified Extensible Firmware Interface (UEFI) does not support multi-threaded execution. When a UEFI program is suspended during execution, the application stops responding and other operations become impossible. One option may be to restart the electronic device and collect the UEFI program execution log to analyze the cause of the hang. However, restarting the device may negatively affect user experience. The execution log may not be saved due to the restart of the device, making it difficult to analyze the cause of the hang.

### SUMMARY

In one aspect, the present disclosure provides a program execution method. The method includes: during a Unified Extensible Firmware Interface (UEFI) boot process, determining a core in a processor that executes a UEFI application as a first core; using the first core to allocate a first function code in the UEFI application to a second core in the processor for execution, the first core being different from the second core, the first function code being code for executing a UEFI boot task; and in response to an abnormality in the second core, using the first core to allocate the first function code to a third core in the processor for execution, the third core being different from the first and second cores.

In another aspect, the present disclosure provides an electronic device. The device includes: a memory storing computer program instructions; and a processor coupled to the memory and configured to execute the computer program instructions and perform: during a Unified Extensible Firmware Interface (UEFI) boot process, determining a core in the processor that executes a UEFI application as a first core; using the first core to allocate a first function code in the UEFI application to a second core in the processor for execution, the first core being different from the second core, the first function code being code for executing a UEFI boot task; and in response to an abnormality in the second core, using the first core to allocate the first function code to a third core in the processor for execution, the third core being different from the first and second cores.

In yet another aspect, the present disclosure provides a non-transitory computer-readable storage medium storing computer program instructions executable by at least one processor to perform: during a Unified Extensible Firmware Interface (UEFI) boot process, determining a core in the processor that executes a UEFI application as a first core; using the first core to allocate a first function code in the UEFI application to a second core in the processor for execution, the first core being different from the second core, the first function code being code for executing a UEFI boot task; and in response to an abnormality in the second core, using the first core to allocate the first function code to a third core in the processor for execution, the third core being different from the first and second cores.

### BRIEF DESCRIPTION OF THE DRAWINGS

The objects, features, and advantages of certain embodiments of the present disclosure become readily apparent by reading the following detailed description with reference to the accompanying drawings. The accompanying drawings illustrate certain embodiments of the present disclosure by way of example and not limitation, where:

In the accompanying drawings, identical or corresponding reference numerals denote identical or corresponding parts.

FIG. 1 illustrates a flowchart diagram of a program execution method according to certain embodiments of the present disclosure;

FIG. 2 illustrates a flowchart diagram of a program execution method according to certain embodiments of the present disclosure;

FIG. 3 illustrates a flowchart diagram of a program execution method according to certain embodiments of the present disclosure;

FIG. 4 illustrates a schematic diagram of a program execution device according to certain embodiments of the present disclosure; and

FIG. 5 illustrates a schematic diagram of an electronic device according to certain embodiments of the present disclosure.

### DETAILED DESCRIPTION

To make the objectives, features, and advantages of the present disclosure more apparent and understandable, the following provides a description of the technical solutions in certain embodiments of the present disclosure, in conjunction with the accompanying drawings. The described embodiments represent only a portion of the embodiments of the present disclosure, and not all of them. All other embodiments devised by those skilled in the technical field according to the embodiments of the present disclosure without inventive effort are within the scope of protection of the present disclosure.

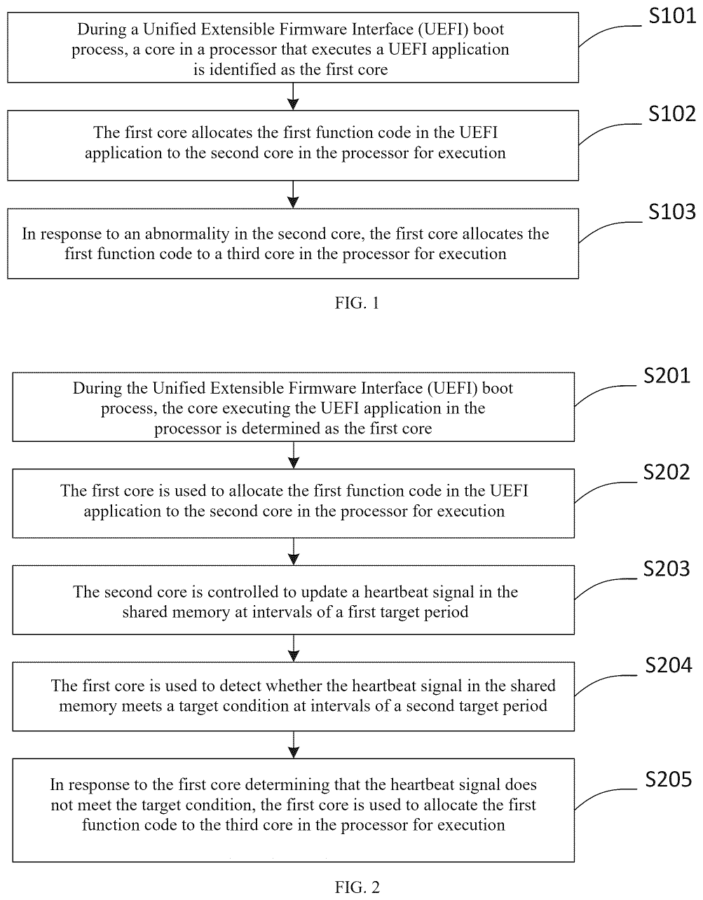

FIG. 1 shows a flowchart of a program execution method according to certain embodiments of this disclosure. As shown in FIG. 1, the program execution method includes:

S101: During a Unified Extensible Firmware Interface (UEFI) boot process, a core in a processor that executes a UEFI application is identified as the first core.

In certain embodiments, the processor is a multi-core central processing unit (CPU). The multi-core CPU includes multiple cores, each of which may independently execute programs. During the UEFI boot process of the electronic device, the core in the multi-core CPU that executes the UEFI application is determined as the first core. The first core is also the boot-strap processor (BSP) responsible for booting the device. The other cores other than the first core are application processors (APs). The multiple cores of the multi-core CPU may determine the first core that executes the UEFI application through a competition mechanism, or according to identification information of the BSP pre-configured in the multi-core CPU, such as the core identifier and core number, to determine the first core that executes the UEFI application.

S102: The first core allocates the first function code in the UEFI application to the second core in the processor for execution.

In certain embodiments, the first function code in the UEFI application is the code that performs the UEFI boot task, for example, the primary function code in the UEFI application. The second core is a core other than the first core in a multi-core CPU. After determining the first core to execute the UEFI application, the first core may be used to allocate the first function code in the UEFI application to the second core for execution. The first core controls the allocation of the first function code, while the second core executes the first function code.

S103: In response to an abnormality in the second core, the first core allocates the first function code to a third core in the processor for execution.

In certain embodiments, when the second core fails during execution of the first function code, the first core may be used to reallocate the first function code to a third core in the multi-core CPU for execution. The third core is different from the first and second cores. When the third core fails during execution of the first function code, the first core may be used to reallocate the first function code to a fourth core in the multi-core CPU. The fourth core is different from the first, second, and third cores, and so on. When the second core fails, the first core may reclaim control of the first function code, reloading the first function code to the first core for execution.

In certain embodiments, when the core executing the first function code fails, the first function code may be reallocated to another core in the processor. This prevents the UEFI application from becoming unresponsive. Users see via the user interface (UI) that the UEFI application freezes and then automatically reloads, without having to restart the electronic device. This improves the user experience and allows for direct collection of UEFI application execution logs to analyze the cause of the freeze, thereby quickly troubleshooting anomalies during the UEFI boot process.

In certain embodiments, S102 of allocating the first function code in the UEFI application to the second core in the processor for execution includes:

The first core allocates the first function code in the UEFI application to the second core in the processor for execution according to the second function code in the UEFI application. The second function code is used to allocate code in the first core to another core for execution.

In certain embodiments, the UEFI application includes a first function code and a second function code. The first function code is the code that performs the UEFI boot task, for example, the main function code in the UEFI application. The second function code is used to allocate code in the first core to another core for execution. In one example, the StartupThisAP function in the first core of the BSP may pass function code to a designated AP. After calling the StartupThisAP function in non-blocking mode, the first core may execute the next task without waiting for the AP to complete executing the function code. The first core is switched to non-blocking mode. The CreateEvent function may be called to create an event and pass it to the WaitEvent function of the StartupThisAP function for status monitoring, thereby switching the first core to non-blocking mode. The second function code may be allocated to the designated second core for execution using the StartupThisAP function and the CreateEvent function. The CreateEvent function may be used to create an event and pass it to the StartupThisAP function, switching the BSP to non-blocking mode. This allows the StartupThisAP function to allocate the first function code to another AP for execution without affecting the execution of the second function code on the BSP.

FIG. 2 shows a flow diagram of a program execution method according to certain embodiments of the present disclosure. As shown in FIG. 2, the program execution method includes:
S201: During the Unified Extensible Firmware Interface (UEFI) boot process, the core executing the UEFI application in the processor is determined as the first core.
S202: The first core is used to allocate the first function code in the UEFI application to the second core in the processor for execution.

The implementation details of S201-S202 are similar to those of S101-S102 and are not further described here.
S203: The second core is controlled to update a heartbeat signal in the shared memory at intervals of a first target period.

In certain embodiments, the shared memory is accessible to all cores of the processor. After the first function code in the UEFI application is allocated to the second core in the processor for execution, the second core may be controlled to update a heartbeat signal in the shared memory at intervals of the first target period. The heartbeat signal may indicate whether the second core is functioning properly.
S204: The first core is used to detect whether the heartbeat signal in the shared memory meets a target condition at intervals of a second target period.
S205: In response to the first core determining that the heartbeat signal does not meet the target condition, the first core is used to allocate the first function code to the third core in the processor for execution.

In certain embodiments, the first core may check whether the heartbeat signal in the shared memory meets the target condition every second target period. When the heartbeat signal does not meet the target condition, it indicates that the second core is abnormal. The first core may be used to allocate the first function code to the third core in the processor for execution. When the heartbeat signal meets the target condition, it indicates that the second core is normal. The second target period may be the same as or different from the first target period. When the first core does not detect the heartbeat signal in the shared memory, it is determined that the heartbeat signal does not meet the target condition. When the first core detects that the heartbeat signal in the shared memory is different from a preset target signal, it is determined that the heartbeat signal does not meet the target condition. After checking whether the heartbeat signal in the shared memory meets the target condition, the first core clears the data in the shared memory so that the second core may continue to update the heartbeat signal in the shared memory.

In certain embodiments, the heartbeat mechanism is used to detect whether the second core is abnormal. When the second core is abnormal, the first core may be used to allocate the first function code to the third core in the processor for execution, thereby preventing UEFI applications from being unresponsive and improving the user experience.

In certain embodiments, after S102 of allocating the first function code in the UEFI application to the second core of the processor for execution, the program execution method further includes:
Setting the priority of the process associated with the second core to a higher priority or a highest priority, the higher the priority of the process is, the earlier the process is executed.
Increasing the memory and disk space corresponding to the second core.
Adjusting the operation frequency and voltage of the second core to target thresholds.

In the present disclosure, after using the first core to allocate the first function code in the UEFI application to the second core in the processor for execution, in order to help ensure the efficient execution of the first function code in the second core, the system resources of the electronic device are adjusted to better the performance of the second core. The adjustment method includes: setting the priority of the process allocated to the second core to a higher priority or the highest priority, thereby ensuring that the process of the second core is executed first; increasing the memory space and disk space corresponding to the second core may reduce memory access delay and improve disk read and write efficiency, thereby ensuring the execution efficiency of the first function code; adjusting the operation frequency and operating voltage of the second core to the target threshold may enhance the computing power of the second core and speed up the response time of the second core, thereby further ensuring the execution efficiency of the first function code, where the target threshold may be set according to an implementation scenario. The present disclosure does not cast limit the target threshold. The target threshold may not be too high, to avoid unwanted excess power consumption of the processor, shortened battery life, and excess heat generated by the processor, or shortened lifespan of the processor.

In certain embodiments, a program execution method includes:
Determining, by the first core, the cause of the second core's abnormality according to the second core's runtime log and debugging information; and, by the first core, remediating the second core's abnormality according to the cause of the abnormality.

In the present disclosure, when the second core experiences an abnormality, after allocating the first function code to the third core in the processor for execution, the first core may access and analyze the second core's runtime log and debugging information to determine the cause of the second core's abnormality. According to the cause of the abnormality, the abnormality in the second core may be remediated, thereby resolving the abnormality during the UEFI boot process and ensuring subsequent normal operation of the processor.

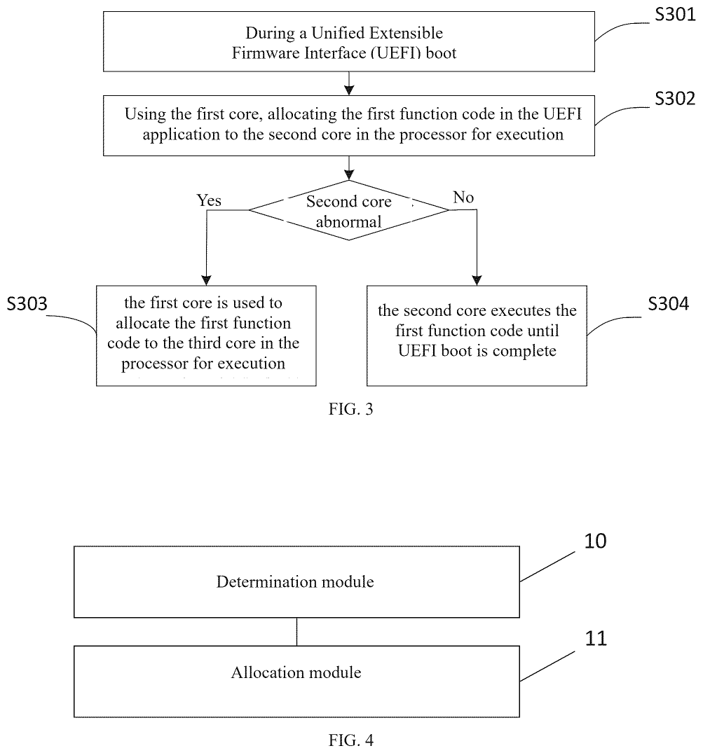

FIG. 3 illustrates a flow diagram of a program execution method according to certain embodiments of the present disclosure. As shown in FIG. 3, the program execution method includes:
S301: During a Unified Extensible Firmware Interface (UEFI) boot process, determining the core in the processor that executes a UEFI application as the first core.
S302: Using the first core, allocating the first function code in the UEFI application to the second core in the processor for execution.

The implementation details of S301-S302 are similar to those of S101-S102 and are not further described here.

When the second core is abnormal, S303 is executed, where the first core is used to allocate the first function code to the third core in the processor for execution.

The implementation details of S303 are similar to those of S103 and are not further described here.

When the second core is normal, S304 is executed, where the second core executes the first function code until UEFI boot is complete.

In the present disclosure, after the first core allocates the first function code in the UEFI application to the second core in the processor for execution, when the heartbeat mechanism detects that the second core is normal, the second core may continue to execute the first function code until UEFI boot is complete, and the event created by the CreateEvent function is closed.

FIG. 4 shows a schematic diagram of the structure of a program execution device according to certain embodiments of the present disclosure. As shown in FIG. 4, the program execution device includes:

A determination module 10 is configured to, during a Unified Extensible Firmware Interface (UEFI) boot process, determine that a core in a processor that executes a UEFI application is a first core; an allocation module 11 is configured to, using the first core, allocate a first function code in the UEFI application to a second core in the processor for execution; the first core is different from the second core, and the first function code is code for executing a UEFI boot task; and the allocation module 11 is configured to, in response to an abnormality in the second core, allocate the first function code to a third core in the processor for execution, using the first core; the third core is different from the first and second cores.

In certain embodiments, the allocation module 11 is configured to: allocate, via the first core, the first function code in the UEFI application to the second core of the processor for execution according to the second function code in the UEFI application. The second function code is used to allocate code in the first core to other cores for execution.

In certain embodiments, the allocation module 11 is configured to: control the second core to update a heartbeat signal in shared memory at a first target period. The shared memory is accessible to all cores of the processor.

In certain embodiments, the allocation module 11 is configured to: utilize the first core to detect whether the heartbeat signal in the shared memory meets a target condition at a second target period; and, in response to the first core determining that the heartbeat signal does not meet the target condition, set the priority of the process associated with the second core to the highest priority. The higher the priority of the process is, the sooner the process is executed.

In certain embodiments, the allocation module 11 is configured to: increase the memory and disk space corresponding to the second core.

The operation frequency and voltage of the second core are adjusted to target thresholds. In certain embodiments, a program execution device includes: a remediation module, configured to determine the cause of the exception of the second core according to the operation log and debugging information of the second core through the first core; and remediate the exception of the second core according to the cause of the exception through the first core.

In certain embodiments, a program execution device includes: an execution module for, in response to the second core being normal, executing the first function code through the second core until UEFI booting is performed.

According to certain embodiments of the present disclosure, the present disclosure also provides an electronic device and a readable storage medium.

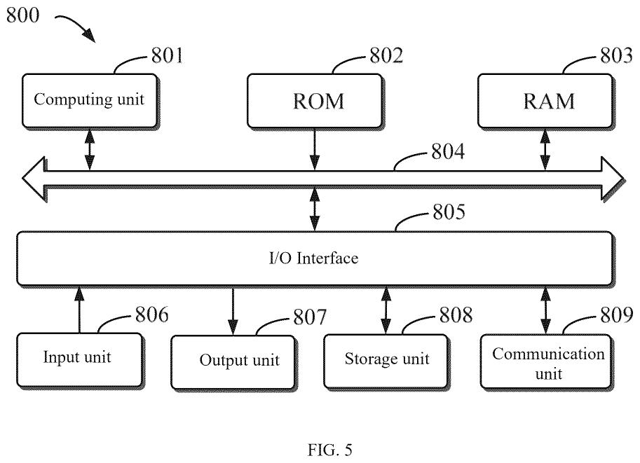

FIG. 5 shows a schematic block diagram of an electronic device 800 that may be used to implement certain embodiments of the present disclosure. The electronic device is intended to represent various forms of digital computers, such as laptops, desktop computers, workstations, personal digital assistants, servers, blade servers, mainframe computers, and other suitable computers. The electronic device may also represent various forms of mobile devices, such as personal digital assistants, cellular phones, smartphones, wearable devices, and other similar computing devices. The components shown herein, their connections and relationships, and their functions are examples and are not intended to limit the implementation of the present disclosure described and/or claimed herein.

As shown in FIG. 5, device 800 includes a computing unit 801 that may perform various appropriate actions and processes according to a computer program stored in a read-only memory (ROM) 802 or loaded from a storage unit 808 into a random access memory (RAM) 803. In the RAM 803, various programs and data for the operation of the device 800 may also be stored. The computing unit 801, the ROM 802, and the RAM 803 are connected to one another via a bus 804. An input/output (I/O) interface 805 is also connected to the bus 804.

Multiple components in device 800 are connected to I/O interface 805, including: an input unit 806, such as a keyboard and mouse; an output unit 807, such as various types of displays and speakers; a storage unit 808, such as a magnetic disk and optical disk; and a communication unit 809, such as a network card, a modem, or a wireless communication transceiver. Communication unit 809 allows device 800 to exchange information/data with other devices via a computer network such as the Internet and/or various telecommunications networks.

Computing unit 801 may be any general-purpose or specialized processing component with processing and computing capabilities. Some examples of computing unit 801 include, but are not limited to, a central processing unit (CPU), a graphics processing unit (GPU), various specialized artificial intelligence (AI) computing chips, various computing units that run machine learning model algorithms, a digital signal processor (DSP), and any suitable processor, controller, microcontroller, or the like.

Computing unit 801 performs the various methods and processes described above, such as a program execution method. For example, in certain embodiments, a program execution method may be implemented as a computer software program tangibly embodied in a machine-readable medium, such as storage unit 808. In certain embodiments, part or all of the computer program may be loaded and/or installed onto the device 800 via the ROM 802 and/or the communication unit 809. When the computer program is loaded into the RAM 803 and executed by the computing unit 801, one or more steps of the program execution method described above may be performed. In certain embodiments, the computing unit 801 may be configured to perform a program execution method in any other appropriate manner (for example, via firmware).

Various implementations of the systems and techniques described herein may be implemented in digital electronic circuit systems, integrated circuit systems, field programmable gate arrays (FPGAs), application specific integrated circuits (ASICs), application specific standard products (ASSPs), systems on chips (SoCs), programmable logic devices (CPLDs), computer hardware, firmware, software, and/or combinations thereof. These various implementations may include implementation in one or more computer programs that are executable and/or interpreted on a programmable system comprising at least one programmable processor, which may be a special-purpose or general-purpose programmable processor that may receive data and instructions from and transmit data and instructions to a storage system, at least one input device, and at least one output device.

Program code for implementing the methods of the present disclosure may be written in any combination of one or more programming languages. This program code may be provided to a processor or controller of a general-purpose computer, special-purpose computer, or other programmable data processing device, such that, when executed by the processor or controller, the program code causes the functions/operations specified in the flowcharts and/or block diagrams to be implemented. The program code may execute entirely on the machine, partly on the machine, partly on the machine as a stand-alone software package and partly on a remote machine, or entirely on the remote machine or server.

In the context of the present disclosure, a machine-readable medium may be a tangible medium that may contain or store a program for use by or in connection with an instruction execution system, apparatus, or device. A machine-readable medium may be a machine-readable signal medium or a machine-readable storage medium.

Machine-readable media may include, but are not limited to, electronic, magnetic, optical, electromagnetic, infrared, or semiconductor systems, apparatuses, or devices, or any suitable combination of the foregoing. Non-limiting examples of machine-readable storage media may include electrical connections according to one or more wires, a portable computer disk, a hard disk, random access memory (RAM), read-only memory (ROM), erasable programmable read-only memory (EPROM or flash memory), optical fiber, a compact disc (CD-ROM), optical storage devices, magnetic storage devices, or any suitable combination thereof.

To provide user interaction, the systems and techniques described herein may be implemented on a computer having a display device (for example, a CRT (cathode ray tube) or LCD (liquid crystal display) monitor) for displaying information to the user; and a keyboard and pointing device (for example, a mouse or trackball) through which the user may provide input to the computer. Other types of devices may be used to provide user interaction; for example, feedback provided to the user may be any form of sensory feedback (for example, visual feedback, auditory feedback, or tactile feedback); and input from the user may be received in any form (including acoustic input, voice input, or tactile input).

The systems and techniques described herein may be implemented in a computing system that includes backend components (for example, as a data server), or a computing system that includes middleware components (for example, an application server), or a computing system that includes frontend components (for example, a user computer with a graphical user interface or web browser through which a user may interact with certain embodiments of the systems and techniques described herein), or a computing system that includes any combination of such backend components, middleware components, or frontend components. The components of the system may be interconnected by any form or medium of digital data communication (for example, a communication network). Examples of communication networks include a local area network (LAN), a wide area network (WAN), and the Internet.

A computer system may include a client and a server. The client and server are generally remote from each other and typically interact via a communication network. This client-server relationship is established by computer programs running on the respective computers and establishing a client-server relationship with each other. The server may be a cloud server, a server in a distributed system, or a server integrated with a blockchain.

Various forms of the processes shown above may be used, with steps reordered, added, or deleted. For example, the steps described in certain embodiments may be performed in parallel, sequentially, or in a different order, as long as the desired results of the technical solutions disclosed herein are achieved. This is not intended to limit the present disclosure.

When applicable, terms “first” and “second” are used for descriptive purposes only and are not construed to indicate or imply relative importance or to implicitly specify the number of technical features indicated. Features designated “first” or “second” may explicitly or implicitly include at least one of such features. When applicable, term “plurality” means two or more, unless otherwise defined.

The above description refers to certain embodiments of the present disclosure, but the scope of protection of the present disclosure is not limited thereto. Any changes or substitutions that may be readily conceived by a person skilled in the technical field within the technical scope disclosed are within the scope of protection of the present disclosure. Therefore, the scope of protection of the present disclosure is according to the scope of protection of the claims.

What is claimed is:

1. A program execution method, the method comprising:
during a Unified Extensible Firmware Interface (UEFI) boot process, determining a core in a processor that executes a UEFI application as a first core;
using the first core to allocate a first function code in the UEFI application to a second core in the processor for execution, the first core being different from the second core, the first function code being code for executing a UEFI boot task; and
in response to an abnormality in the second core, using the first core to allocate the first function code to a third core in the processor for execution, the third core being different from the first and second cores.

2. The method of claim 1, wherein allocating the first function code includes:
using the first core, allocating the first function code in the UEFI application to the second core in the processor for execution according to a second function code in the UEFI application, wherein the second function code is a code for allocating code in the first core to another core for execution.

3. The method of claim 1, after using the first core to allocate the first function code in the UEFI application to the second core in the processor for execution, further comprising:
controlling the second core to detect a heartbeat signal in a shared memory at a first target interval, wherein the shared memory is accessible to all cores of the processor.

4. The method of claim 3, wherein responding to the second core abnormality includes:
using the first core to detect whether the heartbeat signal in the shared memory meets a target condition at a second target interval; and
in response to the first core determining that the heartbeat signal does not meet the target condition, using the first core to allocate the first function code to the third core.

5. The method of claim 1, after using the first core to allocate the first function code in the UEFI application to the second core in the processor for execution, further comprising one or more of:
setting the priority of the process associated with the second core to a highest priority, wherein the higher the priority of the process, the sooner the process is executed;
increasing a memory and disk space corresponding to the second core;
adjusting an operation frequency of the second core; and
adjusting an operation voltage of the second core.

6. The method of claim 1, further comprising:
determining, by the first core, a cause of the second core's abnormality based on the second core's operation log and debugging information;
remediating, by the first core, the abnormality of the second core based on the cause of the abnormality.

7. The method of claim 1, further comprising:
in response to the second core being normal, executing the first function code by the second core.

8. An electronic device, comprising: a memory storing computer program instructions; and
a processor coupled to the memory and configured to execute the computer program instructions and perform:
during a Unified Extensible Firmware Interface (UEFI) boot process, determining a core in the processor that executes a UEFI application as a first core;
using the first core to allocate a first function code in the UEFI application to a second core in the processor for execution, the first core being different from the second core, the first function code being code for executing a UEFI boot task; and
in response to an abnormality in the second core, using the first core to allocate the first function code to a third core in the processor for execution, the third core being different from the first and second cores.

9. The electronic device of claim 8, wherein allocating the first function code includes:
using the first core, allocating the first function code in the UEFI application to the second core in the processor for execution according to a second function code in the UEFI application, wherein the second function code is a code for allocating code in the first core to another core for execution.

10. The electronic device of claim 8, wherein after using the first core to allocate the first function code in the UEFI application to the second core in the processor for execution, the processor is further configured to perform:
controlling the second core to detect a heartbeat signal in a shared memory at a first target interval, wherein the shared memory is accessible to all cores of the processor.

11. The electronic device of claim 10, wherein responding to the second core abnormality includes:
using the first core to detect whether the heartbeat signal in the shared memory meets a target condition at a second target interval; and
in response to the first core determining that the heartbeat signal does not meet the target condition, using the first core to allocate the first function code to the third core.

12. The electronic device of claim 8, wherein after using the first core to allocate the first function code in the UEFI application to the second core in the processor for execution, the processor is further configured to perform one or more of:
setting the priority of the process associated with the second core to a highest priority, wherein the higher the priority of the process, the sooner the process is executed;
increasing a memory and disk space corresponding to the second core;
adjusting an operation frequency of the second core; and
adjusting an operation voltage of the second core.

13. The electronic device of claim 8, wherein the processor is further configured to perform:
determining, by the first core, a cause of the second core's abnormality based on the second core's operation log and debugging information;
remediating, by the first core, the abnormality of the second core based on the cause of the abnormality.

14. The electronic device of claim 8, wherein the processor is further configured to perform:
in response to the second core being normal, executing the first function code by the second core.

15. A non-transitory computer-readable storage medium storing computer program instructions executable by at least one processor to perform:
during a Unified Extensible Firmware Interface (UEFI) boot process, determining a core in the processor that executes a UEFI application as a first core;
using the first core to allocate a first function code in the UEFI application to a second core in the processor for execution, the first core being different from the second core, the first function code being code for executing a UEFI boot task; and
in response to an abnormality in the second core, using the first core to allocate the first function code to a third core in the processor for execution, the third core being different from the first and second cores.

16. The non-transitory computer-readable storage medium of claim 15, wherein allocating the first function code includes:
using the first core, allocating the first function code in the UEFI application to the second core in the processor for execution according to a second function code in the UEFI application, wherein the second function code is a code for allocating code in the first core to another core for execution.

17. The non-transitory computer-readable storage medium of claim 15, wherein after using the first core to allocate the first function code in the UEFI application to the second core in the processor for execution, the computer program instructions are executable by at least one processor to further perform:
controlling the second core to detect a heartbeat signal in shared memory at a first target interval, wherein the shared memory is accessible to all cores of the processor.

18. The non-transitory computer-readable storage medium of claim 17, wherein responding to the second core abnormality includes:
using the first core to detect whether the heartbeat signal in the shared memory meets a target condition at a second target interval; and
in response to the first core determining that the heartbeat signal does not meet the target condition, using the first core to allocate the first function code to the third core.

19. The non-transitory computer-readable storage medium of claim 15, wherein after using the first core to allocate the first function code in the UEFI application to the second core in the processor for execution, the computer program instructions are executable by at least one processor to further perform one or more of:
setting the priority of the process associated with the second core to a highest priority, wherein the higher the priority of the process, the sooner the process is executed;
increasing a memory and disk space corresponding to the second core;
adjusting an operation frequency of the second core; and
adjusting an operation voltage of the second core.

20. The non-transitory computer-readable storage medium of claim 15, wherein the computer program instructions are executable by at least one processor to further perform:
determining, by the first core, a cause of the second core's abnormality based on the second core's operation log and debugging information;
remediating, by the first core, the abnormality of the second core based on the cause of the abnormality.
